(19) United States
(12) Patent Application Publication
(10) Pub. No.: US 2014/0337657 A1
(43) Pub. Date: Nov. 13, 2014

(54) DESIGN SUPPORT DEVICE, DESIGN SUPPORT METHOD, AND COMPUTER-READABLE RECORDING MEDIUM HAVING STORED THEREIN DESIGN SUPPORT PROGRAM

(71) Applicant: FUJITSU LIMITED, Kawasaki-shi (JP)

(72) Inventors: Yuuki Watanabe, Toyohashi (JP); Yasuo Amano, Nukata (JP); Masashi Arayama, Gamagori (JP)

(21) Appl. No.: 14/341,881

(22) Filed: Jul. 28, 2014

Related U.S. Application Data
(63) Continuation of application No. PCT/JP2012/052262, filed on Feb. 1, 2012.

(51) Int. Cl. G06F 1/06

(52) U.S. Cl. CPC G06F 1/06
USPC 713/501

(57) ABSTRACT

When a sequential circuit to which a clock signal distributed by a first buffer included in a clock distribution circuit is input is added, in a case where a plurality of other sequential circuits are connected to the first buffer, a processor determines whether or not a distance between the sequential circuit to be added and the first buffer is between a maximum value and a minimum value of distances between the first buffer and the plurality of other sequential circuits based on the physical design data stored in the memory, and, as a result of the determination, in a case where the distance between the sequential circuit to be added and the first buffer is between the maximum value and the minimum value, the processor performs wiring processing of the clock signal supplied from the first buffer for the sequential circuit to be added.

### CROSS-REFERENCE TO RELATED APPLICATION

This application is a continuation application of International Application PCT/JP2012/052262 filed on Feb. 1, 2012 and designated the U.S., the entire contents of which are incorporated herein by reference.

### FIELD

The present invention relates to a design support device, a design support method, and a computer-readable recording medium having stored therein a design support program.

### BACKGROUND

Generally, the design of a semiconductor integrated circuit of large scale integration (LSI) or the like is performed in the sequence illustrated in FIG. 16. FIG. 16 is a flowchart (Steps S1 to S7) that schematically illustrates a general design sequence of an integrated circuit.

First, after logic design of a design target circuit is performed (Step S1), the arrangement of circuit elements is performed based on the result of the logic design (Step S2). The circuit elements, for example, include a flip-flop (FF; sequential circuit), a random access memory (RAM), and the like.

After the circuit elements are arranged, for circuit elements to which a clock signal is to be supplied, a clock distribution circuit that distributes and supplies the clock signal is generated and arranged (Step S3). The clock distribution circuit includes one supply source element that outputs the clock signal and a plurality of stages of buffers (clock distribution macros) arranged from the supply source element to each circuit element. When the clock distribution circuit is arranged, it is determined whether or not the clock skew of the color distribution circuit after the arrangement is within the limit range (Step S4). Here, the clock skew is the amount of deviation between timing at which a clock signal arrives at a circuit element and timing at which the same clock signal arrives at another circuit element.

In a case where the clock skew is determined not to be within the limit range (No route of Step S4), the rearrangement of the clock distribution circuit is performed until the clock skew is determined to be within the limit range in Step S4 (Step S5). In a case where the clock skew is determined to be within the limit range in Step S4 (Yes route of Step S4), after the wiring of the clock distribution circuit is performed (Step S6), the wiring of a general circuit (between circuit elements) other than the clock distribution circuit is performed (Step S7). The result of the design acquired in this way is stored in a memory as physical design data.

In recent developments of the LSI, the clock frequency tends to become higher every year, and it is important to adjust the clock skew at the time of distributing a clock signal to each FF. In a case where an FF and a RAM are added in accordance with a logic change or the like after a circuit is designed, in other words, physical design data of a design target circuit is acquired in the design sequence illustrated in FIG. 16, it is necessary to newly distribute a clock signal to the FF and the RAM that have been added in consideration of the clock skew. As a technique for distributing a clock signal to the FF and the RAM that have been added, conventionally, for example, the following four kinds of techniques (1) to (4) are employed. Hereinafter, the FF and the RAM that have been added may be described as added FF/RAM.

Technique (1): Clock signals are distributed to the added FF/RAM using physical design data acquired for existing circuits. More specifically, the added FF/RAM is connected to a buffer that is closest to the added FF/RAM, and the clock skew is adjusted through buffer insertion or detour wiring between the buffer and the added FF/RAM.

Technique (2): A clock distribution circuit that distributes and supplies a clock signal to a circuit element including the added FF/RAM is generated and arranged again, and, for circuits other than the clock distribution circuit, connection relation and arrangement information included in physical design data acquired for the existing circuit is used.

Technique (3): A circuit designer manually performs the distribution of a clock signal to circuit elements including an added FF/RAM by using physical design data acquired for an existing circuit.

Technique (4): For all the circuits including an added FF/RAM, a clock distribution circuit, and a general circuit, in the design sequence (see Steps S2 to S7 from arrow A) illustrated in FIG. 16, the process of arranging circuit elements, the process of generating/arranging a clock distribution circuit, and a wiring process are performed again.

However, in the above-described Techniques (1) to (4), there are the following problems.

In Technique (1), the adjustment of a delay between the added FF/RAM and the buffer closest to the added FF/RAM is performed through buffer insertion or wiring detouring that is based on a result of a delay calculation. Not only it takes time to perform the delay calculation, but also it is difficult to configure the clock skew to be within the limit range through the adjustment once. Thus, the adjustment of the delay is repeated several times.

In Technique (2), all the clock distribution circuits are generated/ arranged from the start, and in Technique (4), all the circuits are generated/arranged from the start. Accordingly, although there is physical design data relating to an existing circuit, it takes a design time equivalent to that at first-time design, and the timing adjustment of a large scale circuit takes a lot of time.

In Technique (3), since the circuit designer manually distributes a clock signal to circuit elements including the added FF/RAM, not only is it time-consuming, but also there is a limitation on the circuit scale that can be handled.

As above, according to a conventional technique, in a case where there is a change in the design relating to a clock tree, the clock design is performed again, or the delay calculation for a changed portion of the clock tree is performed again, and the adjustment through buffer insertion or detour wiring is repeated. Accordingly, the number of processes increases so as to require a more time. Hereinafter, the clock distribution circuit may be referred to as a clock tree.

### SUMMARY

According to the present invention, there is provided a design support device including a memory configured to store physical design data of a circuit that includes a clock distribution circuit having a buffer and a processor. The above-described processor, when a sequential circuit to which a clock signal distributed by a first buffer included in the clock distribution circuit is input is added, in a case where a plurality of other sequential circuits are connected to the first buffer, determines whether or not a distance between the sequential circuit to be added and the first buffer is between a maximum value and a minimum value of distances between the first buffer and the plurality of other sequential circuits based on the physical design data stored in the memory, and, as a result of the determination, in a case where the distance between the sequential circuit to be added and the first buffer is between the maximum value and the minimum value, the processor performs wiring processing of the clock signal supplied from the first buffer for the sequential circuit to be added.

In addition, according to the present invention, there is provided a method of performing design support using a processor based on physical design data of a circuit that includes a clock distribution circuit having a buffer, physical design data being stored in a memory. The method includes determining whether or not a distance between a sequential circuit to be added and a first buffer is between a maximum value and a minimum value of distances between the first buffer and the plurality of other sequential circuits based on the physical design data in a case where a plurality of other sequential circuits are connected to the first buffer when the sequential circuit to which a clock signal distributed by the first buffer included in the clock distribution circuit is input is added and performing wiring processing of the clock signal supplied from the first buffer for the sequential circuit to be added in a case where the distance between the sequential circuit to be added and the first buffer is between the maximum value and the minimum value as a result of the determining.

Furthermore, according to the present invention, there is provided a design support program for causing a computer to execute a process for performing design support based on physical design data of a circuit including a clock distribution circuit having a buffer, physical design data being stored in a memory. The process includes determining whether or not a distance between a sequential circuit to be added and a first buffer is between a maximum value and a minimum value of distances between the first buffer and the plurality of other sequential circuits based on the physical design data in a case where a plurality of other sequential circuits are connected to the first buffer when the sequential circuit to which a clock signal distributed by the first buffer included in the clock distribution circuit is input is added and performing wiring processing of the clock signal supplied from the first buffer for the sequential circuit to be added in a case where the distance between the sequential circuit to be added and the first buffer is between the maximum value and the minimum value as a result of the determining.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram that illustrates the hardware configuration and the functional configuration of a design support device according to an embodiment.

FIG. 2 is a diagram that illustrates a specific example of individual maximum proximity and individual minimum proximity of a final stage buffer according to this embodiment.

FIG. 3 is a diagram that illustrates an example of the distribution of the distance from a processing target buffer to an FF/RAM or buffer of the next stage.

FIG. 4 is a diagram that illustrates a specific example of estimated maximum proximity and estimated minimum proximity of a processing target buffer according to this embodiment.

FIG. 5 is a diagram that illustrates a specific example of maximum proximity and minimum proximity of a non-final-stage buffer according to this embodiment.

FIG. 6 is a diagram that illustrates a specific example of an added FF/RAM present outside the proximity range of the final stage buffer according to this embodiment.

FIG. 7 is a diagram that illustrates a wiring possible area for wiring from the final stage buffer to an existing FF/RAM according to this embodiment.

FIG. 8 is a diagram that illustrates estimated minimum wiring distances between the added FF/RAM and a plurality of wiring possible areas according to this embodiment.

FIGS. 9 to 11 are diagrams that illustrate specific examples of a determination of the proximity of the added FF/RAM and clock signal wiring for the added FF/RAM according to this embodiment.

FIG. 12 is a flowchart that schematically illustrates the design sequence of an integrated circuit to which a design support function according to this embodiment is applied.

FIG. 13 is a flowchart that schematically illustrates the sequence of clock signal distribution according to the design support function of this embodiment in a case where an FF/RAM is added in accordance with the occurrence of a logic change.

FIGS. 14 and 15 are flowcharts that illustrate the sequence of clock signal distribution according to the design support function of this embodiment in detail in a case where an FF/RAM is added in accordance with the occurrence of a logic change.

FIG. 16 is a flowchart that schematically illustrates a general design sequence of an integrated circuit.

### DESCRIPTION OF THE PREFERRED EMBODIMENTS

Hereinafter, embodiments will be described with reference to the drawings.

### [1] Operation Principle Of Design Support Function According To This Embodiment

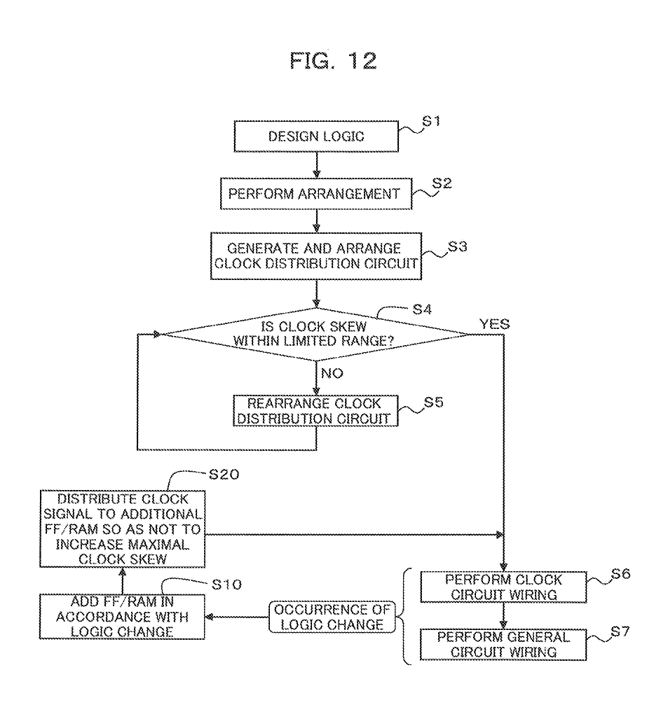

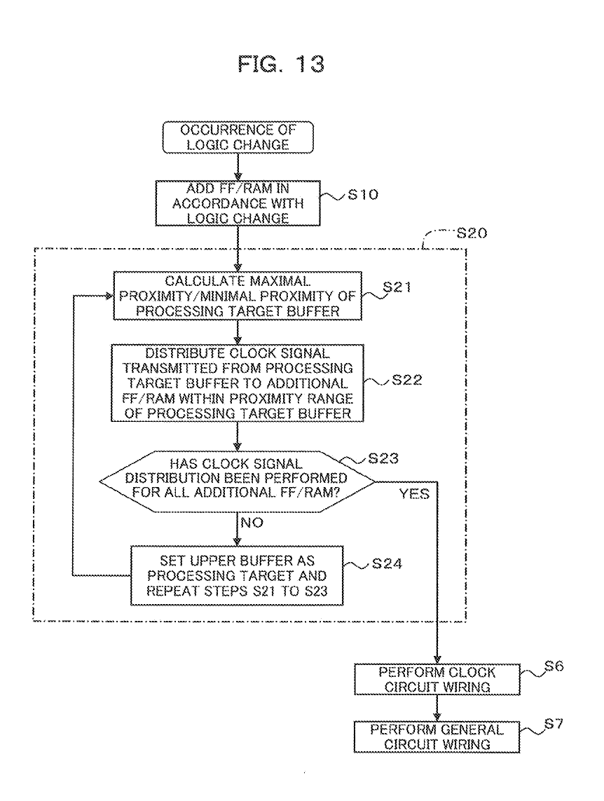

The operation principle of a design support function according to this embodiment will be described with reference to FIGS. 12 and 13.

First, the design sequence of an integrated circuit to which a design support function according to this embodiment is applied will be schematically described along a flowchart (Steps S1 to S7, S10, and S20) illustrated in FIG. 12.

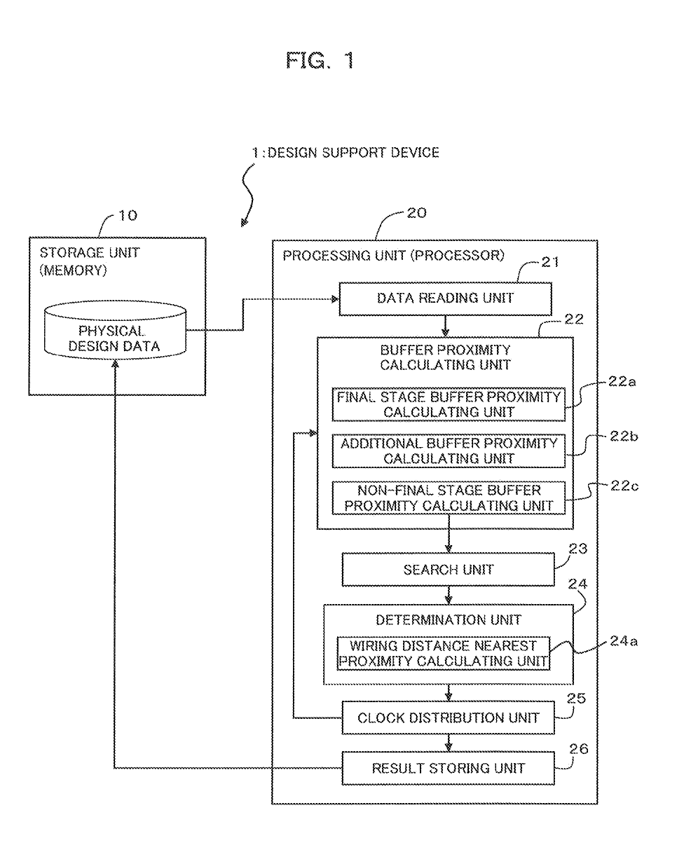

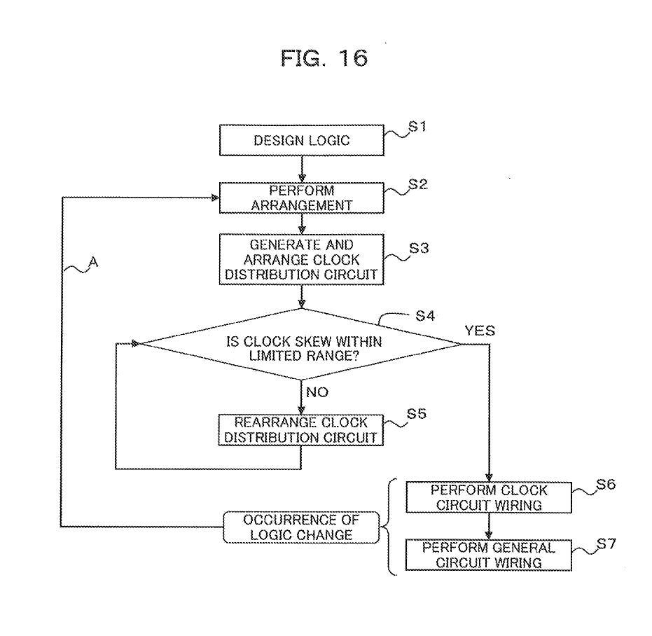

In the design support function according to this embodiment, a design result acquired through Steps S1 to S7 illustrated in FIG. 12 is stored in a memory (see reference numeral 10 illustrated in FIG. 1) as physical design data of an existing circuit. Steps S1 to S7 are as described with reference to FIG. 16, and thus description thereof will not be presented. As above, when a change in the logic or the like occurs after the design of a design target circuit in advance, there is a case where an FF or a RAM is added. At that time, an operation for arranging the circuit block of the FF or the RAM is performed (Step S10).

Then, according to the design support function of this embodiment, by using the physical design data stored in the memory, the distribution of a clock signal to the FF or the RAM that has been added is automatically performed while the maximum clock skew of the existing circuit is maintained (Step S20). Thereafter, the process of wiring the clock signal is performed (Step S6), and the process of wiring a general circuit is performed (Step S7). A result of the design after the change in the logic that is acquired in this way is stored in the memory as the physical design data.

Next, the sequence of clock signal distribution according to the design support function of this embodiment in a case where a sequential circuit is added in accordance with the occurrence of a change in the logic will be schematically described along a flowchart (Steps S10, S21 to S24, S6, and S7) illustrated in FIG. 13. In FIG. 13, Step S20 illustrated in FIG. 12 is illustrated more specifically as Steps S21 to S24. Steps S6 and S7 are as described above, and thus, detailed description thereof will not be presented.

When an FF or a RAM is added in accordance with the occurrence of a change in the logic or the like after the design of the design target circuit in advance, as described above, an operation of arranging a circuit block of the FF or the RAM is performed (Step S10). However, in this step, the circuit block is arranged only, but the connection arrangement of a clock wiring and the like is not performed, and next, a clock skew and the like need to be considered.

According to the design support function of this embodiment, a logical connection between the added FF/RAM and a buffer is realized in the sequence (Steps S21 to S24) to be described below in consideration of the clock skew, whereby a clock signal is distributed to the added FF/RAM (Step S6). In addition, when the process according to Step S21 is started, a final stage buffer (first buffer) of the clock distribution circuit in the existing physical design data is set as a processing target buffer (processing target distribution macro).

In Step S21, first, based on the physical design data of the existing circuit, a maximum value and a minimum value of a distance from a buffer included in the clock distribution circuit to an existing FF/RAM connected to the buffer or another existing buffer are calculated. Hereinafter, positions at which the distance is the maximum value and the minimum value will be referred to as maximum proximity and minimum proximity. In addition, an area between the maximum proximity and the minimum proximity will be referred to as a proximity range.

In the design support function according to this embodiment, since the existing circuit defined in the physical design data has been verified in Step S4 illustrated in FIG. 12, the existing circuit is on the premise of being in the state of operating without causing a clock skew problem. In other words, it is assumed that the clock distribution circuit relating to the added FF/RAM operates without causing any clock skew problem unless the clock skew relating to the added FF/RAM exceeds the maximum clock skew (the limit range of the clock skew) of the existing circuit.

Accordingly, in Step S21, maximum proximity (a maximum value of the distance) in which the clock skew of the clock signal arriving from the buffer to the FF/RAM or the buffer in the existing circuit is assumed to be a maximum is calculated. Similarly, in Step S21, minimum proximity (a minimum value of the distance) in which the clock skew of the clock signal arriving from the buffer to the FF/RAM in the existing circuit is assumed to be a minimum is calculated

Next, in Step S22, based on the maximum proximity and the minimum proximity acquired in Step S21, a proximity range between the maximum proximity and the minimum proximity is acquired, and a clock signal is distributed from the processing target buffer to the added FF/RAM that is present within the acquired proximity range. In other words, it is determined whether or not a distance between the added FF/RAM and the processing target buffer is between the maximum value and the minimum value, and, in a case where the distance is between the maximum value and the minimum value, a clock signal is distributed from the processing target buffer to the added FF/RAM.

Thereafter, in Step S23, it is determined whether or not the clock signal has been distributed to all the added FF/RAM's. In a case where the clock signal has been distributed to all the added FF/RAM's (Yes route of Step S23), the process of Steps S6 and S7 described above is performed.

On the other hand, in a case where there is any added FF/RAM to which the clock signal has not been distributed, in other words, in a case where any added FF/RAM is present outside the proximity range (No route of Step S23), the process proceeds to the process of Step S21, and again, the process of Steps S21 to S23 is performed. At that time, a non-final stage buffer (second buffer) disposed on the side upper than the previous processing target buffer by one stage is set as the processing target buffer. The process of Steps S21 to S24 described above is repeatedly performed until the clock signal is distributed to all the added FF/RAM's (until a Yes determination is made in Step S23).

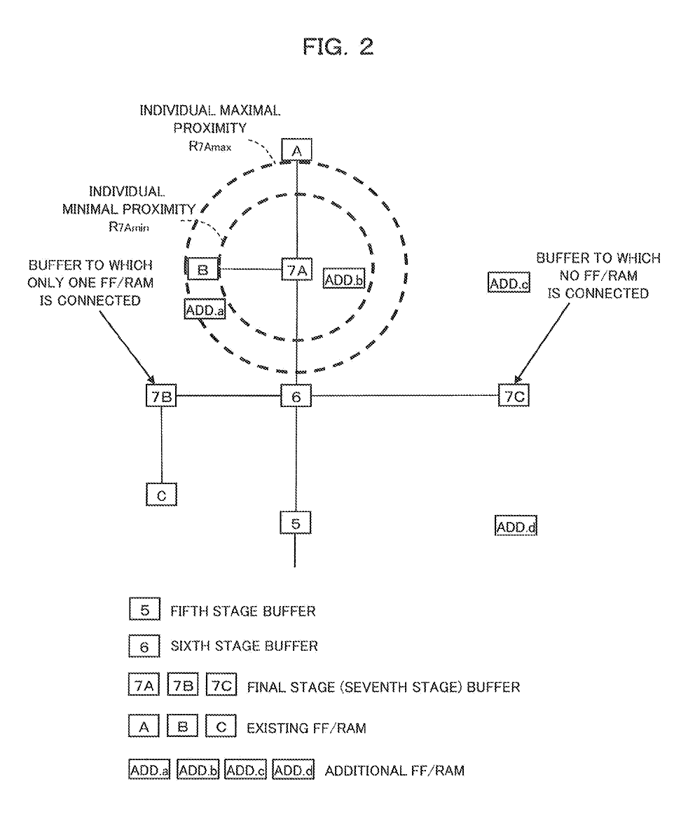

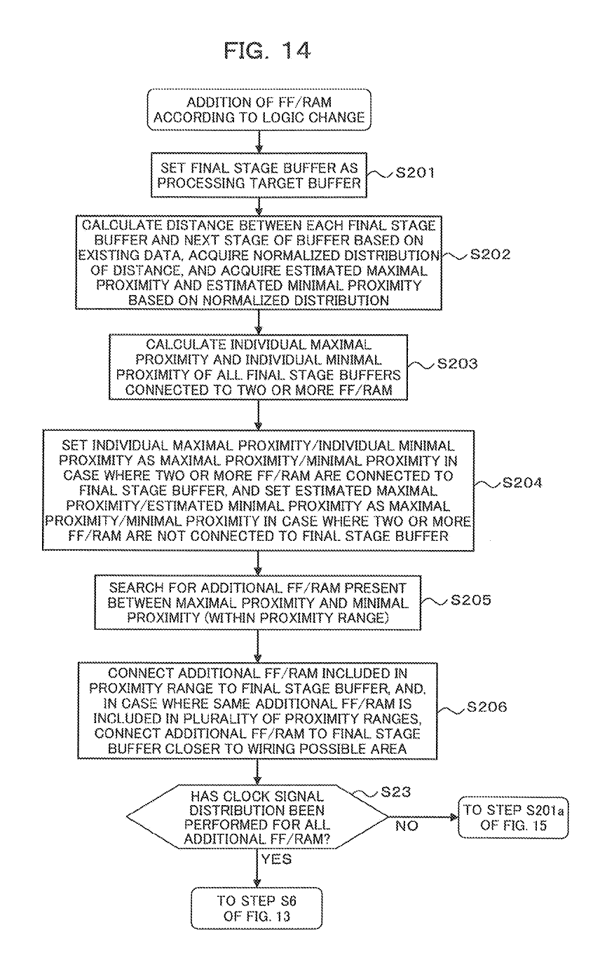

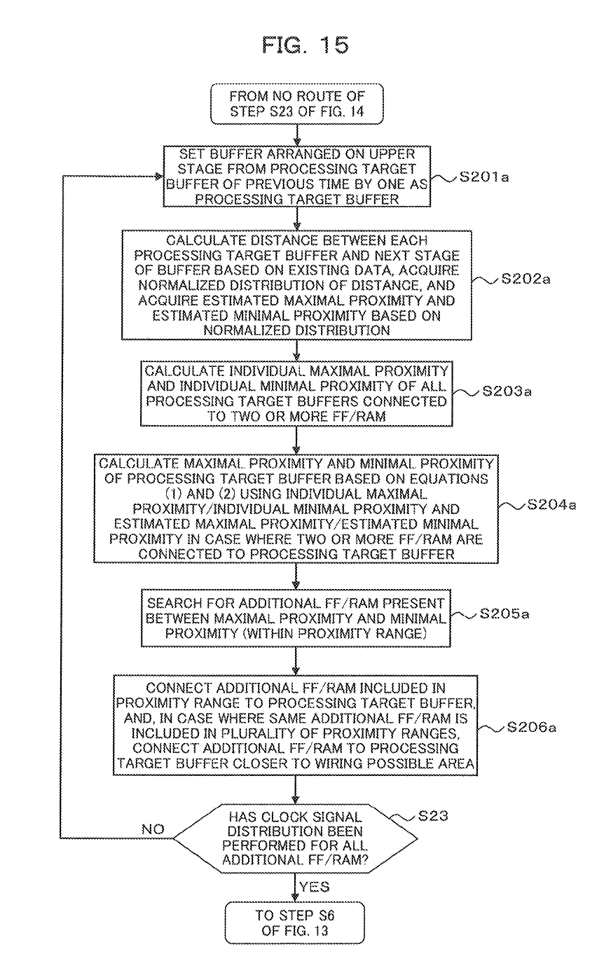

A specific technique for calculating the maximum proximity and the minimum proximity in Step S21 will be described later with reference to FIGS. 2 to 5, Steps S202 to S204 illustrated in FIG. 14, and Steps S202a to S204a illustrated in FIG. 15.

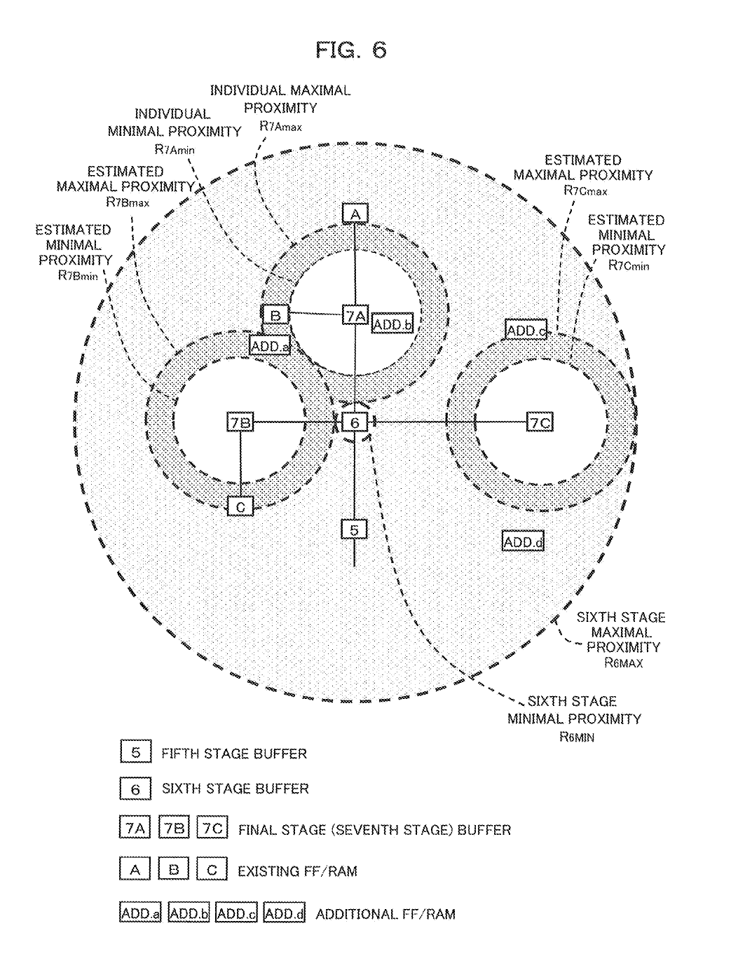

In addition, a specific technique for distributing the clock signal in Step S22 will be described later with reference to FIGS. 6 to 8, Steps S205 and S206 illustrated in FIG. 14, and Steps S205a and S206a illustrated in FIG. 15.

### [2] Configuration Of Design Support Device According To This Embodiment

FIG. 1 is a block diagram that illustrates the hardware configuration and the functional configuration of a design support device 1 according to an embodiment. The design support device 1 illustrated in FIG. 1 supports the design of a semiconductor integrated circuit of the LSI or the like and realizes the design support function of the embodiment described above with reference to FIGS. 12 and 13. The design support device 1 is configured by a computer such as a general personal computer and, in addition to a storage unit (memory) 10 and a processing unit (processor) 20, includes an input unit (not illustrated in the figure) and a display unit (not illustrated in the figure). The memory 10, the processor 20, the display unit, and the input unit are interconnected to be communicable with one another through a bus (not illustrated in the figure).

The memory 10 may be either an internal storage device such as a random access memory (RAM), a hard disk drive (HDD), or a solid state drive (SSD) or an external storage device. The memory 10 not only stores existing physical design data of a design target circuit that is acquired in the design sequence illustrated in FIGS. 12 and 16 but also stores information relating to a change in the physical design data or the like that is acquired by the process, which is performed by the processor 20, to be described later. Here, the design target circuit is a circuit that includes a clock distribution circuit having a buffer (clock distribution macro).

The processor 20 is a central processing unit (CPU) or the like. The processor 20 achieves the function of a data reading unit 21, a buffer proximity calculating unit 22, a search unit 23, a determination unit 24, a clock distribution unit 25, and a result storing unit 26 to be described later by executing a design support program stored in the memory 10 or the like.

The display unit 40 displays various kinds of information generated by the processor 20, for example, a proximity calculation result, a wiring possible area, a clock signal wiring result, and the like to be described later with reference to FIGS. 2 to 11 and is a display such as a cathode ray tube (CRT) or a liquid crystal display (LCD).

The input unit is a man-machine interface that is operated by a designer (user) and inputs various kinds of information to this device 1 and, for example, is a mouse, a keyboard, or the like. Particularly, in this embodiment, the input unit is used when a sequential circuit is additionally input to existing physical design data (existing design target circuit) in accordance with a change in the logic or the like. Here, examples of the sequential circuit include an FF and a RAM, and, hereinafter, an FF and/or a RAM that are added are referred to as an added FF/RAM.

Next, various functions achieved by the processor 20, in other words, the functions of the data reading unit 21, the buffer proximity calculating unit 22, the search unit 23, the determination unit 24, the clock distribution unit 25, and the result storing unit 26 will be described.

When an FF/RAM is added to a designed existing circuit in accordance with a change in the logic or the like, the data reading unit 21 appropriately reads existing physical design data that is necessary for the process of distributing a clock signal to the added FF/RAM from the memory 10.

### [2-1] Function For Calculating Maximum Proximity And Minimum Proximity Of Processing Target Buffer

The buffer proximity calculating unit 22 performs the process according to Step S21 illustrated in FIG. 13, in other words, the process of calculating maximum proximity and minimum proximity of a processing target buffer (processing target distribution macro) based on existing physical design data read by the data reading unit 21.

The buffer proximity calculating unit 22, in order to calculate the maximum proximity and the minimum proximity of three kinds of the processing target buffer described below, has functions of a final stage buffer proximity calculating unit 22a, an additional buffer proximity calculating unit 22b, and a non-final stage buffer proximity calculating unit 22c.

### [2-1-1] Case Where Processing Target Buffer Is Existing Final Stage Buffer (First Buffer) To Which Plurality Of Existing FF/RAM's Are Connected On Lower Stage Side

The final stage buffer proximity calculating unit 22a calculates individual maximum proximity and individual minimum proximity to be described later as maximum proximity and minimum proximity for an existing final stage buffer to which a plurality of (two or more) FF/RAM's are connected on the lower stage side.

More specifically, the final stage buffer proximity calculating unit 22a calculates distances between the final stage buffer that is the processing target and a plurality of existing FF/RAM's connected to the lower stage of the final stage buffer based on existing physical design data. The final stage buffer proximity calculating unit 22a sets a maximum value of the distances calculated for the existing FF/RAM's as individual maximum proximity and sets a minimum value thereof as individual minimum proximity. When the added FF/RAM is located between the individual maximum proximity and the individual minimum proximity of the final stage buffer (within a proximity range), clock skew in the added FF/RAM in a case where a clock signal is distributed from the final stage buffer is within a limit range so as not to deteriorate. Accordingly, the operation of the clock distribution circuit can be assured.

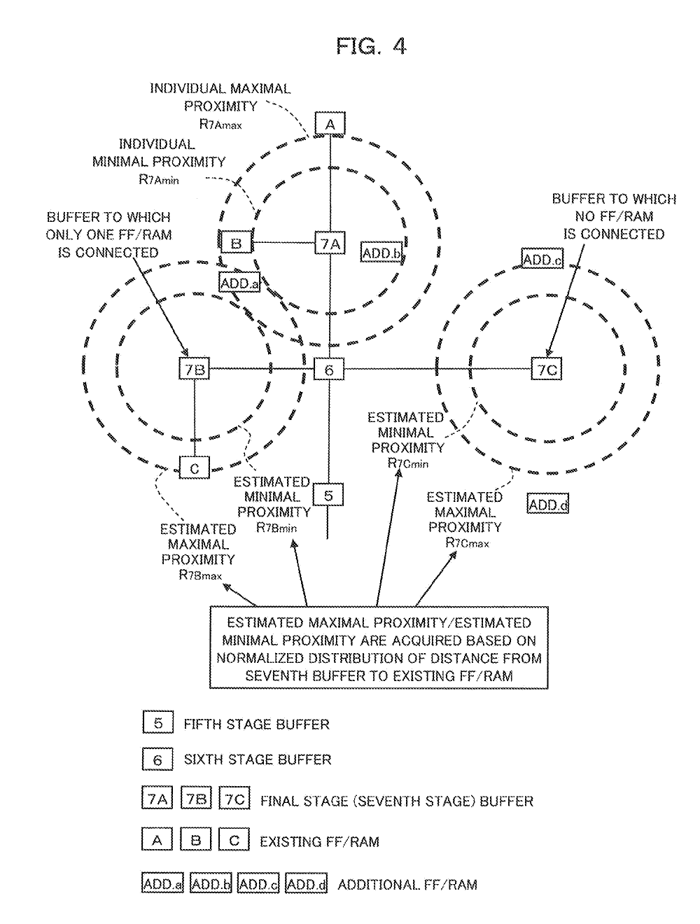

Here, a specific example of the individual maximum proximity and the individual minimum proximity of the final stage buffer will be described with reference to FIG. 2. In FIG. 2, each block represents a buffer and an FF/RAM as below. A block denoted by “5” represents a fifth-stage buffer of the existing clock distribution circuit. In addition, a block denoted by “6” represents a sixth stage buffer of the existing clock distribution circuit. Blocks denoted by “7A”, “7B”, and “7C” respectively represent seventh-stage buffers that are final stage buffers (first buffers) of the existing clock distribution circuit. Blocks denoted by “A”, “B”, and “C” respectively represent existing FF/RAM's. Blocks denoted by “ADD.a”, “ADD.b”, “ADD.c”, and “ADD.d” respectively represent FF/RAM's that are newly added and generated in accordance with a change in the logic or the like of the existing physical design data (a design target circuit that has been designed). In addition, also in FIGS. 4 to 6 and 9 to 11, buffers and FF/RAM's that are the same as those illustrated in FIG. 2 are illustrated as an example, and the same reference signs as those illustrated in FIG. 2 are attached thereto.

As illustrated in FIG. 2, two existing FF/RAM's (A and B) are connected to the lower stage of the existing final stage buffer (7A). In this case, the final stage buffer proximity calculating unit 22a calculates a distance in a straight line between the final stage buffer (7A) and the existing FF/RAM (A) and calculates a distance in a straight line between the final stage buffer (7A) and the existing FF/RAM (B). At this time, a distance in a straight line between the final stage buffer (7A) and the existing FF/RAM (A) that is located farthest from the final stage buffer (7A) has a maximum value, and a distance in a straight line between the final stage buffer (7A) and the existing FF/RAM (B) that is located closest to the final stage buffer (7A) has a minimum value.

Accordingly, a circle having the final stage buffer (7A) as its center and having a distance in a straight line between the final stage buffer (7A) and the existing FF/RAM (A) as its radius is calculated as individual maximum proximity R_{7Amax}. In addition, a circle having the final stage buffer (7A) as its center and having a distance in a straight line between the final stage buffer (7A) and the existing FF/RAM (B) as its radius is calculated as individual minimum proximity R_{7Amin}.

In addition, the calculation of the minimum proximity and the maximum proximity of the buffer (7B), to which only one existing FF/RAM is connected, or the buffer (7C), to which none of the existing FF/RAM is connected, is not able to be performed based on existing connection relation unlike the above-described final stage buffer (7A), even if the buffer (7B or 7C) may be a final stage buffer. Accordingly, the minimum proximity/maximum proximity of such buffers (7B and 7C) are calculated using the additional buffer proximity calculating unit 22b by using another technique (see Section [2-1-2] presented below) to be described later.

### [2-1-2] Case Where Processing Target Buffer Is Added Buffer That Is Newly Generated Or Buffer To Which Two Or More FF/RAM's Or Buffers Are Not Connected On Lower Stage Side

The additional buffer proximity calculating unit 22b calculates estimated maximum proximity and estimated minimum proximity to be described later as the maximum proximity and the minimum proximity for an added buffer that is newly generated, a buffer to which no FF/RAM or buffer is connected on the lower stage side, or a buffer to which one FF/RAM or buffer is connected on the lower stage side.

Here, the maximum proximity and the minimum proximity of a buffer that is the processing target cannot be calculated using the technique described in Section [2-1-1] described above. Thus, the additional buffer proximity calculating unit 22b calculates maximum proximity and minimum proximity of the processing target buffer based on distances from another existing buffer that is disposed on the same stage as that of the processing target buffer to a plurality of existing FF/RAM's connected to the lower stage side of the another existing buffer.

More specifically, the additional buffer proximity calculating unit 22b calculates a distance from the other existing buffer described above to each existing FF/RAM or buffer disposed on the lower stage side of the another existing buffer based on existing physical design data. In addition, the additional buffer proximity calculating unit 22b acquires a mean and a variance of a plurality of the calculated distances and calculates a normalized distribution having the mean and the variance that have been acquired. Then, the additional buffer proximity calculating unit 22b sets s distance (maximum value) corresponding to the upper limit of a fixed range (predetermined range) from the center of the calculated normalized distribution as estimated maximum proximity of the processing target buffer and sets a distance (minimum value) corresponding to a lower limit of the same range as estimated minimum proximity.

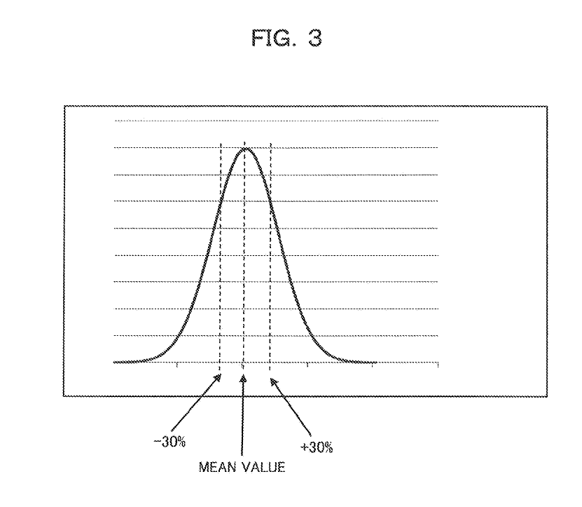

Generally, the distribution of a distance from a buffer (clock distribution macro) to an FF/RAM or buffer of the next stage, as illustrated in FIG. 3, is a normalized distribution. At this time, the above-described fixed range, for example, as illustrated in FIG. 3, is a range of −30% to +30% having the mean value of the normalized distribution as its center, a distance corresponding to −30% is set as the estimated minimum proximity, and a distance corresponding to +30% is set as the estimated maximum proximity. FIG. 3 is a diagram that illustrates an example of the distribution of the distance from a processing target buffer to an FF/RAM or buffer of the next stage.

As above, in a case where the added FF/RAM is arranged within the range corresponding to the periphery of the mean value of the normalized distribution, the maximum clock skew does not increase. In other words, when the added FF/RAM is located between the estimated maximum proximity and the estimated minimum proximity of the processing target buffer (within the proximity range), the clock skew in the added FF/RAM in a case where a clock signal is distributed from the processing target buffer is within the limit range and does not deteriorate. Accordingly, the operation of the clock distribution circuit can be assured.

Here, a specific example of the estimated maximum proximity and the estimated minimum proximity of the processing target buffer will be described with reference to FIG. 4. As illustrated in FIG. 4, only one existing FF/RAM (C) is connected to the lower stage side of the final stage buffer (7B), and none of the existing FF/RAM is connected to the lower stage side of the final stage buffer (7C). In such a case, the additional buffer proximity calculating unit 22b calculates a maximum value corresponding to the upper limit and a minimum value corresponding to the lower limit based on the normalized distribution of a distance in a straight line from the seventh stage buffer to an existing FF/RAM of the next stage.

In this way, as illustrated in FIG. 4, a circle having the final stage buffer (7B) as its center and having the maximum value as its radius is calculated as estimated maximum proximity R_{7Bmax}, and a circle having the final stage buffer (7B) as its center and having the minimum value as its radius is calculated as individual minimum proximity R_{7Bmin}. In addition, a circle having the final stage buffer (7C) as its center and having the maximum value as its radius is calculated as estimated maximum proximity R_{7Cmax}, and a circle having the final stage buffer (7C) as its center and having the minimum value as its radius is calculated as estimated minimum proximity R_{7Cmin}.

### [2-1-3] Case Where Processing Target Buffer Is Non-Final Stage Buffer (Second Buffer)

The non-final stage buffer proximity calculating unit 22c calculates maximum proximity and minimum proximity for a non-final stage buffer that is disposed on the upper stage side of the final stage buffer.

More specifically, the non-final stage buffer proximity calculating unit 22c calculates a maximum value (to be described later) of a distance at which a clock signal can be distributed from a non-final stage buffer to an added FF/RAM as maximum proximity based on existing physical design data. Similarly, the non-final stage buffer proximity calculating unit 22c calculates a minimum value (to be described later) of the distance at which a clock signal can be distributed from a non-final stage buffer to an added FF/RAM as minimum proximity based on the existing physical design data.

Here, the non-final stage buffer proximity calculating unit 22c calculates a maximum value of the clock-signal distributable distance as maximum proximity of a non-final stage buffer that is the processing target by using the following Equation (1). In other words, the maximum proximity of the non-final stage buffer has a value that is acquired by adding a sum of maximum values (individual maximum proximity or estimated maximum proximity) for buffers of a next-stage buffer to a final stage buffer to a maximum value (individual maximum proximity) of distances in a straight line from a non-final stage buffer, which is the processing target, to a plurality of next-stage buffers connected to the lower stage side of the non-final stage buffer.

In addition, the non-final stage buffer proximity calculating unit 22c calculates a minimum value of the clock-signal distributable distances as minimum proximity of the non-final stage buffer that is the processing target by using the following Equation (2). In other words, the minimum proximity of the non-final stage buffer has a larger value of a value acquired by subtracting a sum (individual maximum proximity or estimated maximum proximity) of maximum values acquired for buffers from a next-stage buffer to a final stage buffer from a minimum value (individual minimum proximity) of a distance in a straight line from the non-final stage buffer, which is the processing target, to a plurality of next-stage buffers connected to the lower stage side of the non-final stage buffer and zero. In other words, in a case where the value acquired by the subtraction described above is less than zero, the minimum proximity (minimum value) of the non-final stage buffer is zero.

[Maximum Proximity of Non-Final Stage Buffer]=[Individual Maximum Proximity of Non-Final Stage Buffer As Processing Target]+[Sum of Individual Maximum Proximities or Estimated Maximum Proximities of Next-Stage Buffer to Final Stage Buffer] (1)

[Minimum Proximity of Non-Final Stage Buffer]=max{0, [Individual Minimum Proximity of Non-Final Stage Buffer as Processing Target]−[Sum of Individual Maximum Proximities or Estimated Maximum Proximities of Next-Stage Buffer to Final Stage Buffer]} (2)

In addition, when the maximum proximity and the minimum proximity of the non-final stage buffer are calculated based on Equations (1) and (2) described above, in a case where only one next-stage buffer is connected to the non-final stage buffer that is the processing target, instead of the individual maximum proximity/individual minimum proximity, the estimated maximum proximity/estimated minimum proximity described above are used. Similarly, in a case where only one next-stage buffer is connected to buffers from the next-stage buffer to the non-final stage buffer, instead of the individual maximum proximity/individual minimum proximity, the estimated maximum proximity/estimated minimum proximity described above are used.

In a case where the added FF/RAM is located between the maximum proximity and the minimum proximity of the non-final stage buffer (within the proximity range), by adding one or more buffers including the final stage buffer between the added FF/RAM and the non-final stage buffer and distributing a clock signal from the non-final stage buffer to the added FF/RAM, the clock skew in the added FF/RAM is within the limit range and does not deteriorate. Accordingly, the operation of the clock distribution circuit can be assured.

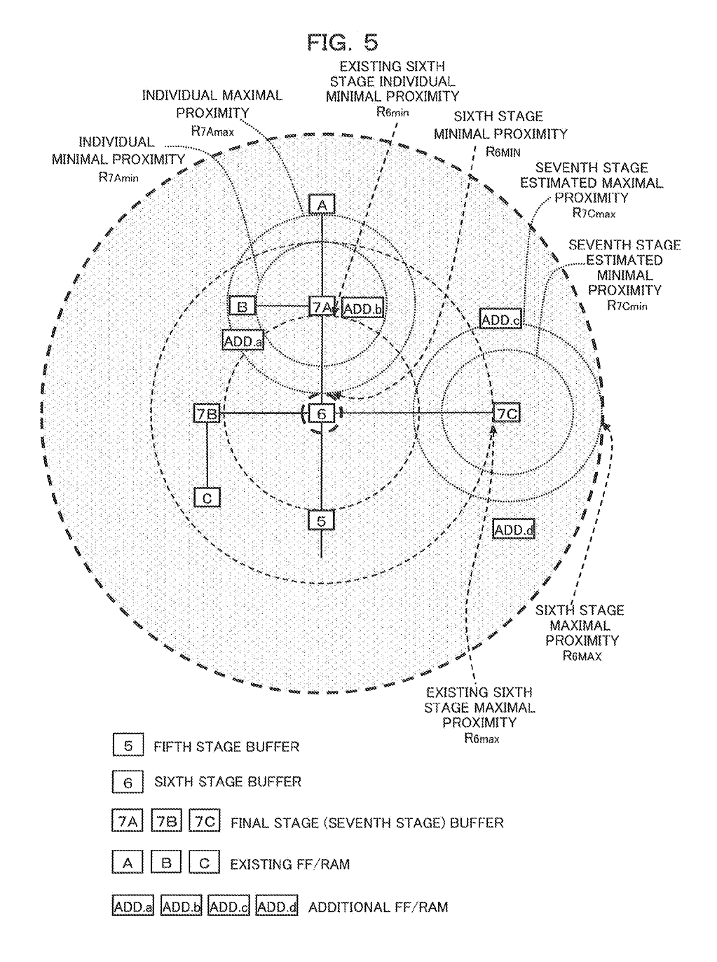

Here, a specific example of the maximum proximity and the minimum proximity of the non-final stage buffer will be described with reference to FIG. 5. In FIG. 5, the maximum proximity and the minimum proximity of a non-final stage buffer (6) of the sixth stage are illustrated. Three buffers (7A, 7B, and 7C) are connected to the lower stage of the non-final stage buffer (6) of the sixth stage. At this time, a distance in a straight line between the non-final stage buffer (6) and the final stage buffer (7C) that is farthest from the non-final stage buffer (6) has a maximum value, and a distance in a straight line between the non-final stage buffer (6) and the final stage buffer (7A or 7B) that is closest to the non-final stage buffer (6) has a minimum value.

Accordingly, a circle having the non-final stage buffer (6) as its center and having a distance in a straight line between the non-final stage buffer (6) and the buffer (7C) as its radius is calculated as individual maximum proximity R₆ₘₐₓ of the non-final stage buffer (6). In addition, a circle having the non-final stage buffer (6) as its center and having a distance in a straight line between the non-final stage buffer (6) and the buffer (7A or 7B) as its radius is calculated as individual minimum proximity R₆ₘᵢₙ of the non-final stage buffer (6).

In addition, since none of the existing FF/RAM is connected to the lower stage of the final stage buffer (7C) that is farthest from the non-final stage buffer (6), for the final stage buffer (7C), as described with reference to FIG. 4, the estimated maximum proximity R_{7Cmax} and the estimated minimum proximity R_{7Cmin} are acquired. At this time, a circle having the non-final stage buffer (6) as its center and having a value acquired by adding the radius value of the estimated maximum proximity R_{7Cmax} of the final stage buffer (7C) to the radius value of the individual maximum proximity R₆ₘₐₓ as its radius is calculated as maximum proximity R_{6MAX} of the non-final stage buffer (6).

Meanwhile, two existing FF/RAM's (A and B) are connected to the lower stage of the final stage buffer (7A) that is closest to the non-final stage buffer (6), and, for the final stage buffer (7A), as described above with reference to FIG. 2, the individual maximum proximity R_{7Amax} and the individual minimum proximity R_{7Amin} are acquired. At this time, a circle having the non-final stage buffer (6) as its center and having a value acquired by subtracting the radius value of the estimated maximum proximity R_{7Cmax} of the final stage buffer (7A) from the radius value of the individual minimum proximity R₆ₘᵢₙ as its radius is calculated as minimum proximity R_{6MIN} of the non-final stage buffer (6).

At this time, the added FF/RAM (ADD.d) illustrated in FIG. 5 is present between the maximum proximity R_{6MAX} and the minimum proximity R_{6MIN} of the non-final stage buffer (6) (in the proximity range). Accordingly, by newly generating and adding a final stage buffer (seventh stage buffer) between the added FF/RAM (ADD.d) and the non-final stage buffer (6) and distributing a clock signal from the non-final stage buffer (6) to the added FF/RAM (ADD.d), the clock skew in the added FF/RAM is within the limit range and does not deteriorate. Therefore, the added FF/RAM (ADD.d) can be connected to the non-final stage buffer (6), and the clock signal can be supplied to the added FF/RAM (ADD.d) while the operation of the clock distribution circuit is assured.

### [2-2] Function For Searching Added FF/RAM Within Proximity Range

The search unit 23 acquires an area between the maximum proximity and the minimum proximity, which are calculated by the buffer proximity calculating unit 22, as a proximity range and searches for a FF/RAM, which is included in the proximity range, out of added FF/RAM's that are newly added in accordance with a change in the logic or the like.

The search unit 23, first, searches for an added FF/RAM that is included in a proximity range between the individual maximum proximity and the individual minimum proximity of the final stage buffer, which are acquired by the final stage buffer proximity calculating unit 22a or a proximity range between the estimated maximum proximity and the estimated minimum proximity of the final stage buffer that are acquired by the additional buffer proximity calculating unit 22b. In other words, the search unit 23 determines whether or not a distance between the added FF/RAM and the final stage buffer is between the maximum value and the minimum value of the distance from the final stage buffer to an existing FF/RAM. The clock distribution unit 25 connects the added FF/RAM included in the proximity range of the final stage buffer, which has been found by the search unit 23, to the final stage buffer and distributes a clock signal from the final stage buffer to the added FF/RAM. The result storing unit 26 stores a distribution result of the clock signal according to the clock distribution unit 25 in the memory 10.

In a case where an added FF/RAM that is not included in the proximity range of the final stage buffer, in other words, an added FF/RAM disposed outside the proximity range of the final stage buffer is present, the search unit 23 searches for an added FF/RAM that is included in the proximity range between the maximum proximity and the minimum proximity of the non-final stage buffer, which are acquired by the non-final stage buffer proximity calculating unit 22c, disposed on the upper stage side of the final stage buffer. In other words, the search unit 23 determines whether or not a distance between the added FF/RAM and the non-final stage buffer is between the maximum value and the minimum value of the clock signal distributable distance. The clock distribution unit 25 connects the added FF/RAM included in the proximity range of the non-final stage buffer, which has been found by the search unit 23, to the non-final stage buffer and distributes a clock signal from the non-final stage buffer to the added FF/RAM. The result storing unit 26 stores a distribution result of the clock signal according to the clock distribution unit 25 in the memory 10.

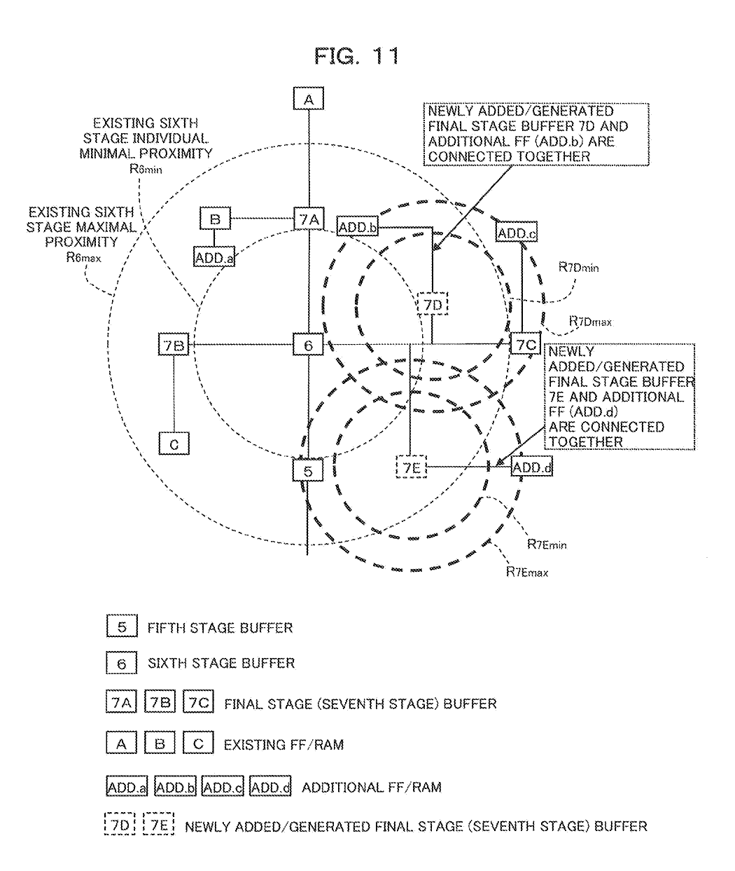

At this time, in a case where a difference n between the stage number of the non-final stage buffer and the stage number of the added FF/RAM is two or more, the clock distribution unit 25 distributes a clock signal from the non-final stage buffer to the added FF/RAM through buffers of (n−1) stages between the non-final stage buffer and the added FF/RAM. For example, in a specific example to be described later with reference to FIG. 6 or 11, the stage number of the non-final stage buffer is six, the stage number of the added FF/RAM is eight, and the difference n is two. Accordingly, a buffer corresponding to one stage, in other words, a seventh-stage buffer is generated and added, and a clock signal is distributed to the added FF/RAM.

As above, in a case where an added FF/RAM disposed outside the proximity range of the final stage buffer is present, a non-final stage buffer disposed on the upper stage side that is upper than the stage of a current processing target buffer by one is selected, and the process of calculating the maximum proximity/minimum proximity according to the buffer proximity calculating unit 22 and the search process according to the search unit 23 are performed as described above. The buffer selecting process, the calculation process, and the search process described above are repeatedly performed until there is no added FF/RAM to which a clock has not be distributed (in other words, all the added FF/RAM's are retrieved) or until the stage number of the processing target buffer is a stage number determined by the designer.

As described above, by distributing a clock signal to the added FF/RAM from the buffer disposed on the upper stage side upper than that of the current processing target buffer by one stage, for example, as illustrated in FIG. 6, to added FF/RAM's disposed within a range broader than the proximity range of the buffer disposed on the lower stage side (final stage), a clock signal can be distributed without degrading the maximum clock skew.

Here, a specific example of added sequential circuits present outside the proximity range of the final stage buffer will be described with reference to FIG. 6. In FIG. 6, four added FF/RAM's (ADD.a, ADD.b, ADD.c, and ADD.d) are illustrated.

The added FF/RAM (ADD.a) belongs to both the proximity range (between the individual maximum proximity R_{7Amax} and the individual minimum proximity R_{7Amin}) of the final stage buffer (7A) and the proximity range (the estimated maximum proximity R_{7Bmax} and the estimated minimum proximity R_{7Bmin}) of the final stage buffer (7B). As above, in a case where the added FF/RAM belongs to the proximity areas of a plurality of final stage buffers, the determination unit 24 to be described later determines one final stage buffer (7A or 7B) as a clock distribution source in accordance with a criterion to be described later. The clock distribution unit 25 distributes a clock signal from the final stage buffer (7A or 7B) determined by the determination unit 24 to the added FF/RAM (ADD.a).

The added FF/RAM (ADD.c) belongs to the proximity range (between the estimation maximum proximity R_{7Cmax} and the estimated minimum proximity R_{7Cmin}) of the final stage buffer (7C). Accordingly, the clock distribution unit 25 distributes a clock signal from the final stage buffer (7C) to the added FF/RAM (ADD.c).

The added FF/RAM (ADD.b) is very close to the final stage buffer (7A) and is not connected thereto but belongs to the outside of proximity range of the final stage buffer (7A). However, the added FF/RAM (ADD.b) belongs to the proximity range (between the maximum proximity R_{6MAX} and the minimum proximity R_{6MIN}) of the non-final stage buffer (6) that is disposed on the upper stage side upper than the final stage buffer (7A) by one stage. Accordingly, the clock distribution unit 25, for example, as will be described later with reference to FIG. 11, distributes a clock signal from the non-final stage buffer (6) to the added FF/RAM (ADD.b) through the seventh stage buffer that is additionally generated.

The added FF/RAM (ADD.d) is very far from the final stage buffer (7C) and is not connected thereto but belongs to the outside of the proximity range of the final stage buffer (7C). However, the added FF/RAM (ADD.d) belongs to the proximity range (between the maximum proximity R_{6MAX} and the minimum proximity R_{6MIN}) of the non-final stage buffer (6) that is disposed on the upper stage side upper than final stage buffer (7C) by one stage. Accordingly, the clock distribution unit 25, for example, as will be described later with reference to FIG. 11, distributes a clock signal from the non-final stage buffer (6) to the added FF/RAM (ADD.d) through the seventh stage buffer that is additionally generated.

As illustrated in FIG. 6, the proximity range of the sixth stage buffer, which is disposed on the upper stage side upper than the seventh stage buffers (7A to 7C) by one stage, is broader than that of each of the seventh stage buffers (7A to 7C). Accordingly, by appropriately generating and adding a lower-stage side buffer, the upper-stage side buffer can distribute a clock signal to a place located farther than a distance at which the lower-stage side buffer can distribute a clock signal.

### [2-3] Determination Function Of Case Where Added FF/RAM Belong To Plurality Of Proximity Ranges

The determination unit 24 includes a wiring distance shortest proximity calculating unit 24a to be described later and achieves a determination function of a case where an added FF/RAM belongs to a plurality of proximity ranges. In a case where the same added FF/RAM belongs to proximity ranges [see an added FF/RAM (ADD.a) belonging to the proximity range of the final stage buffer (7A) and the proximity range of the final stage buffer (7B) illustrated in FIG. 6], the determination unit 24, in order to select one final stage buffer from among the plurality of final stage buffers, makes a determination according to the following Criteria (1) and (2).

Criterion (1): From among a plurality of final stage buffers to which the same added FF/RAM belongs, a final stage buffer having a smallest fan-out number is determined and selected, and a clock signal is distributed to the final stage buffer, which has the smallest fan-out number, at a high priority. As the fan-out number increases, the delay increases, and accordingly, the final stage buffer having the smallest fan-out number has a high priority. Here, the fan-out number is the number of buffers or FF/RAM's connected to the next stage of the processing target buffer.

Criterion (2): In a case where the fan-out numbers of a plurality of final stage buffers to which the same added FF/RAM belongs are the same, from among the plurality of final stage buffers, a final stage buffer having a shortest wiring distance from the added FF/RAM is determined (estimated) and selected, and a clock signal is distributed to the final stage buffer that has the smallest wiring distance. The estimation of the shortest wiring distance is performed by the wiring distance shortest proximity calculating unit 24a of the determination unit 24 as described in the following section [2-4].

### [2-4] Estimation Function Of Shortest Wiring Distance

The wiring distance shortest proximity calculating unit 24a acquires an area (hereinafter, referred to as a wiring possible area), in which there is a possibility of performing the wiring of a clock signal from each final stage buffer to an existing FF/RAM, for each of a plurality of final stage buffers based on existing physical design data. Then, the wiring distance shortest proximity calculating unit 24a estimates a final stage buffer having a shortest distance from the added FF/RAM to the wiring possible area from among the plurality of final stage buffers as a final stage buffer having a shortest wiring distance according to Criterion (2) described above and selects the estimated final stage buffer.

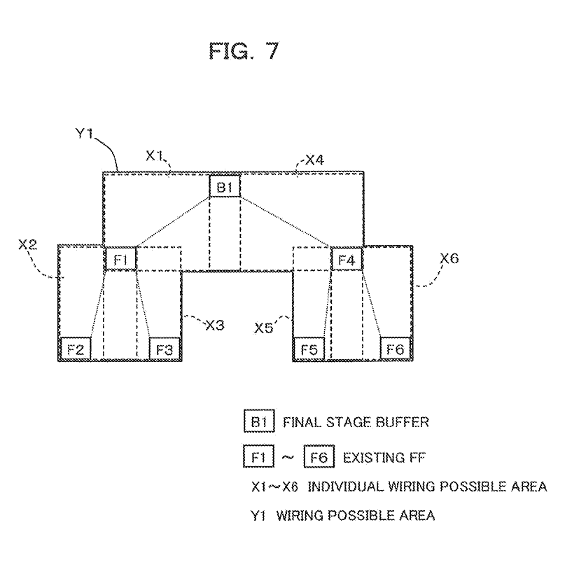

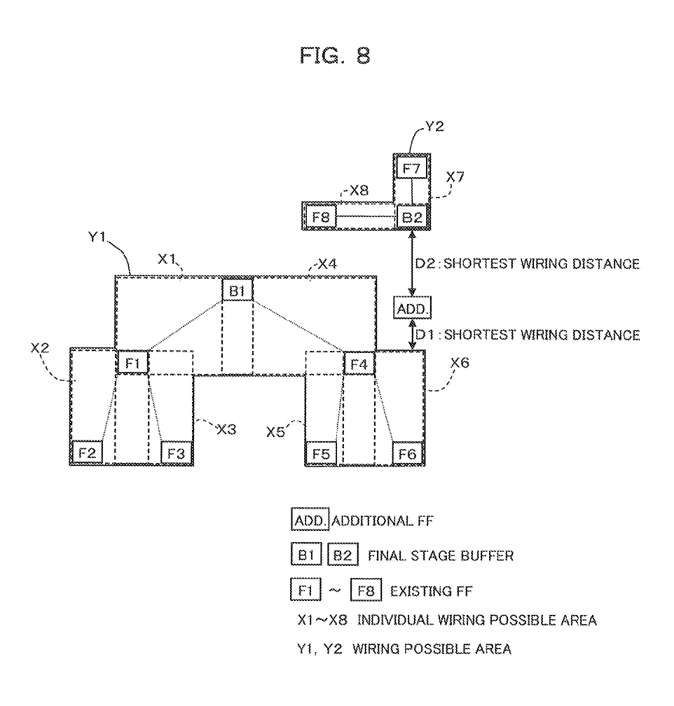

Here, the shortest wiring distance estimating function according to the wiring distance shortest proximity calculating unit 24a will be described more specifically with reference to FIGS. 7 and 8. FIG. 7 is a diagram that illustrates a wiring possible area for wiring from the final stage buffer to an existing FF/RAM according to this embodiment. FIG. 8 is a diagram that illustrates estimated minimum wiring distances between the added FF/RAM and a plurality of wiring possible areas according to this embodiment.

In FIGS. 7 and 8, blocks denoted by “B1” and “B2” illustrates final stage buffers (first buffers). Blocks denoted by “F1” to “F6” illustrate existing FF's to which a clock signal is distributed from the final stage buffer (B1), and blocks denoted by “F7” and “F8” illustrate existing FF's to which a clock signal is distributed from the final stage buffer (B2). A block denoted by “Add” illustrates an FF that is newly added and generated in accordance with a change in the logic or the like. In FIG. 8, an added FF (Add) is assumed to belong to both the proximity range of the final stage buffer (B1) and the proximity range of the final stage buffer (B2). Rectangular areas, to which reference signs X1 to X8 are attached, surrounded by dotted lines illustrate individual wiring possible areas. In addition, areas, to which reference signs Y1 and Y2 are attached, surrounded by solid lines illustrate wiring possible areas for the final stage buffer (B1 and B2).

A wiring possible area X1 in which there is a possibility of performing the wiring of a clock signal from the final stage buffer (B1) to the existing FF's (F1 to F6) is acquired as illustrated in FIGS. 7 and 8. In other words, first, a minimum spanning tree is acquired for the final stage buffer (B1) and the existing FF's (F1 to F6) using a Kruskal algorithm. In the example illustrated in FIGS. 7 and 8, a minimum spanning tree is acquired in which two existing FF's (F1 and F4) are connected to the final stage buffer (B1), two existing FF's (F2 and F3) are connected to the existing FF (F1), and two existing FF's (F5 and F6) are connected to the existing FF (F4).

Then, rectangular areas X1 and X4 having the final stage buffer and the existing FF's connected in the minimum tree as diagonal lines thereof and rectangular areas X2, X3, X5, and X6 having two existing FF's connected in the minimum tree as diagonal lines thereof are acquired as individual wiring possible areas.

In FIGS. 7 and 8, the individual wiring possible area X1 is a rectangular area having the final stage buffer (B1) and the existing FF (F1) as its diagonal line, the individual wiring possible area X2 is a rectangular area having two existing FF's (F1 and F2) as its diagonal line, and the individual wiring possible area X3 is a rectangular area having two existing FF's (F1 and F3) as its diagonal line. In addition, the individual wiring possible area X4 is a rectangular area having the final stage buffer (B1) and the existing FF (F4) as its diagonal line, the individual wiring possible area X5 is a rectangular area having two existing FF's (F4 and F5) as its diagonal line, and the individual wiring possible area X6 is a rectangular area having two existing FF's (F4 and F6) as its diagonal line.

An area Y1 that is a sum of the individual wiring possible areas X1 to X6 acquired as described above is acquired as a wiring possible area of the final stage buffer (B1).

Similarly, as illustrated in FIG. 8, also for the final stage buffer (B2) and the existing FF's (F7 and F8), individual wiring possible areas X7 and X8 are acquired, and an area Y2 that is a sum of such individual wiring possible areas X7 and X8 is acquired as a wiring possible area of the final stage buffer (B2).

In a case where the added FF (Add) belongs to both the proximity area of the final stage buffer (B1) and the proximity area of the final stage buffer (B2), as illustrated in FIG. 8, a shortest wiring distance D1 from the added FF (Add) to the wiring possible area X1 of the final stage buffer (B1) and a shortest wiring distance D2 from the added FF (Add) to the wiring possible area X2 of the final stage buffer (B2) are calculated. Then, a clock signal is distributed to the added FF (Add) from the wiring possible area that is disposed on a side close to the added FF (Add).

In other words, in the example illustrated in FIG. 8, while the added FF (Add) is closer to the final stage buffer (B2) than to the final stage buffer (B1), the wiring distance D2>the wiring distance D1, and accordingly, the added FF is closer to the wiring possible area X1 than to the wiring possible area X2. Accordingly, in a case where a clock signal is distributed to the added FF (Add) from the wiring possible area X1 of the final stage buffer (B1), the amount of added wiring may be allowed to be small. Therefore, the final stage buffer (B1) is selected, and a clock signal is distributed from the final stage buffer (B1).

### Specific Example

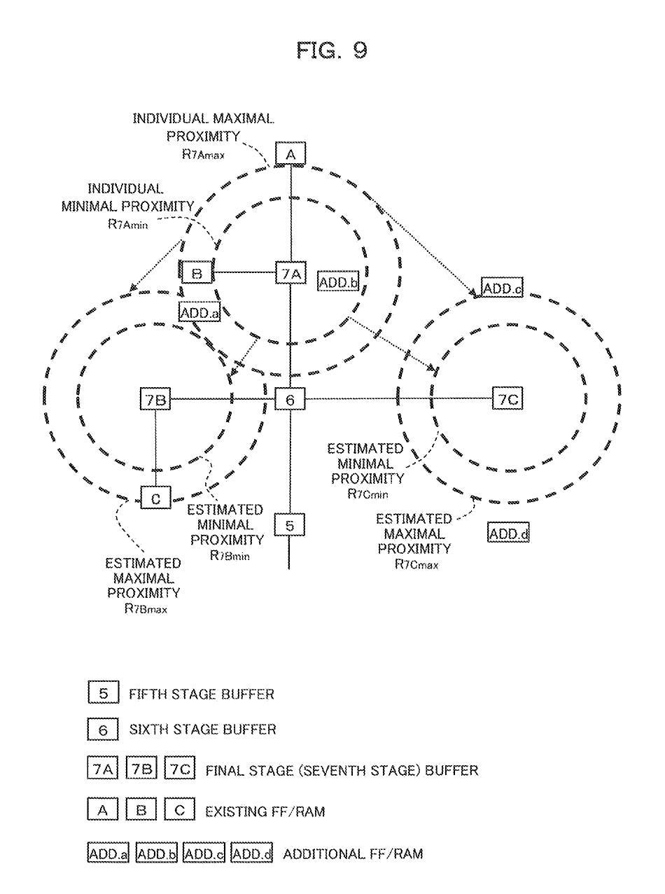

Specific examples of the determination of the proximity of the added FF/RAM and the wiring of a clock signal to the added FF/RAM according to this embodiment will be described with reference to FIGS. 9 to 11.

Also in the specific examples illustrated in FIGS. 9 to 11, it is assumed that added FF/RAM's (ADD.a to ADD.d) that are the same as those of the above-described specific examples described above with reference to FIGS. 2 and 4 to 6 are added to the existing circuit that is the same as that of the specific examples.

First, as illustrated in FIG. 9, maximum proximities R_{7Amax}, R_{7Bmax}, and R_{7Cmax} and minimum proximities R_{Amin}, R_{7Bmin}, and R_{7Cmin} are calculated for the final stage buffers (7A to 7C) of the seventh stage by the buffer proximity calculating unit 22. At this time, for the final stage buffer (7A) to which two or more existing FF/RAM's (A and B) are connected, individual maximum proximity R_{7Amax} and the individual minimum proximity R_{7Amin} are calculated by the final stage buffer proximity calculating unit 22a. For the final stage buffers (7B and 7C) to which two or more existing FF/RAM's (A and B) are not connected, estimated maximum proximities R_{7Bmax} and R_{7Cmax} and estimated minimum proximities R_{7Bmin} and R_{7Cmin} are calculated by the additional buffer proximity calculating unit 22b based on the normalized distribution described above with reference to FIG. 3.

As described above, based on the maximum proximities and the minimum proximities of the final stage buffers (7A to 7C), which have been calculated, the determination unit 23 acquires the proximity ranges of the final stage buffers (7A to 7C) and determines whether or not the added FF/RAM (ADD.a to ADD.d) belongs to the proximity ranges.

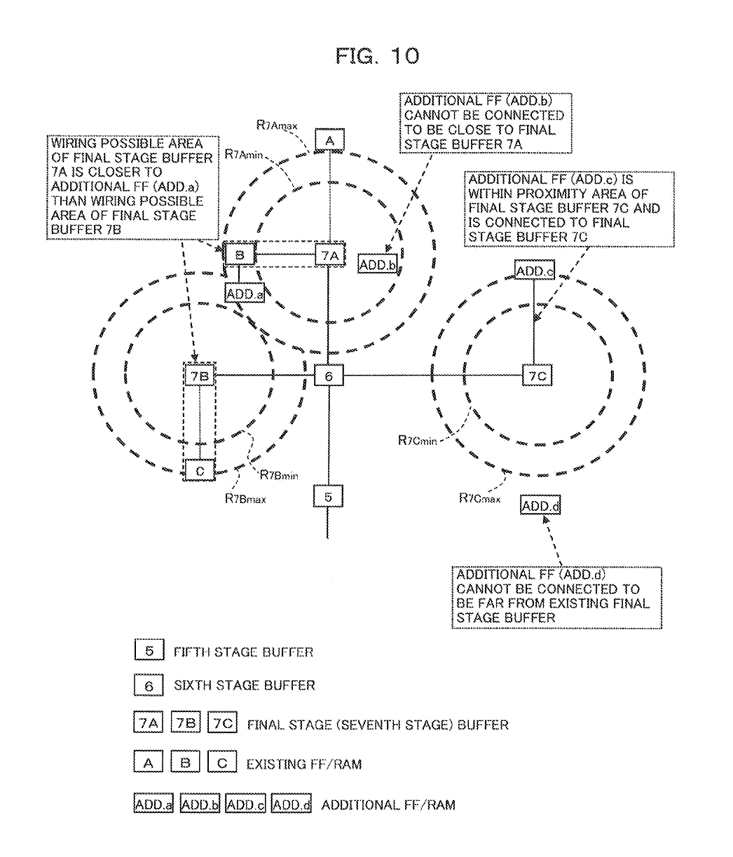

At this time, the added FF/RAM (ADD.c) is determined to belong to the proximity range (between the estimated maximum proximity R_{7Cmax} and the estimated minimum proximity R_{7Cmin}) of the final stage buffer (7C) by the determination unit 23. In accordance with this determination, as illustrated in FIG. 10, the added FF/RAM (ADD.c) is connected to the final stage buffer (7C) by the clock distribution unit 25, and a clock signal is distributed from the final stage buffer (7C) to the added FF/RAM (ADD.c).

In addition, the added FF/RAM (ADD.a) is determined to belong to both the proximity range (between the individual maximum proximity R_{7Amax} and the individual minimum proximity R_{7Amin}) of the final stage buffer (7A) and the proximity range (between the estimated maximum proximity R_{7Bmax} and the estimated minimum proximity R_{7Bmin}) of the final stage buffer (7B) by the determination unit 23. In accordance with this determination, out of two final stage buffers (7A and 7B), a final stage buffer having a smallest fan-out number or a final stage buffer having a closest wiring possible area is determined and selected as a clock distribution source by the determination unit 24a. Here, it is assumed that the wiring possible area of the final stage buffer (7A) is determined to be closer to the added FF/RAM (ADD.a) than the wiring possible area of the final stage buffer (7B), and the final stage buffer (7A) is selected as the clock distribution source. In accordance with this, as illustrated in FIG. 10, the added FF/RAM (ADD.a) is connected to the final stage buffer (7A) by the clock distribution unit 25, and a clock is distributed from the final stage buffer (7A) to the added FF/RAM (ADD.a).

The added FF/RAM's (ADD.b and ADD.d) that are not included in the proximity ranges of the final stage buffers (7A to 7C) of the seventh stage are connected to the non-final stage buffer disposed on the upper stage side, and a clock signal is distributed from the non-final stage buffer disposed on the upper stage side. Here, as illustrated in FIG. 10, the added FF/RAM (ADD.b) is very close to the final stage buffer (7A) and is not connected thereto but belongs to the outside of proximity range of the final stage buffer (7A). The added FF/RAM (ADD.d) is very far from the final stage buffer (7C) and is not connected thereto but belongs to the outside of the proximity range of the final stage buffer (7C).

At this time, as described above with reference to

FIG. 5, the proximity range (between the maximum proximity R_{6MAX} and the minimum proximity R_{6MIN}) is calculated for the non-final stage buffer (6) of the sixth stage by the non-final stage buffer proximity calculating unit 22c. Then, the added FF/RAM's (ADD.b and ADD.d) are determined to belong to the proximity range of the non-final stage buffer (6) by the determination unit 23.

Accordingly, as illustrated in FIG. 11, the clock distribution unit 25, distributes a clock signal from the non-final stage buffer (6) to the added FF/RAM's (ADD.b and ADD.d) through the seventh buffers (7D and 7E) that are newly added and generated.

At this time, the individual maximum proximity R₆ₘₐₓ and the individual minimum proximity R₆ₘᵢₙ, of the sixth stage buffer (6) are acquired. In addition, the proximity range (between the estimated maximum proximity R_{7Dmax} and the estimated minimum proximity R_{7Dmin}) of the seventh stage buffer (7D) that is newly added and generated is acquired by the additional buffer proximity calculating unit 22b based on the normalized distribution described above with reference to FIG. 3. Similarly, the proximity range (between the estimated maximum proximity R_{7Emax} and the estimated minimum proximity R_{7Emin}) of the seventh stage buffer (7E) that is newly added and generated is acquired by the additional buffer proximity calculating unit 22b based on the normalized distribution described above with reference to FIG. 3.

Then, a new buffer (7D) of the seventh stage, as illustrated in FIG. 11, is generated and arranged so as to be located between the individual maximum proximity R₆ₘₐₓ and the individual minimum proximity R₆ₘᵢₙ of the sixth stage buffer (6) and allow the added FF/RAM (ADD.b) to belong to the inside of the proximity range of the new buffer (7D). A clock signal is distributed from the non-final stage buffer (6) to the added FF/RAM (ADD.b) through the new buffer (7D) of the seventh stage that is generated as above.

Similarly, a new buffer (7E) of the seventh stage, as illustrated in FIG. 11, is generated and arranged so as to be located between the individual maximum proximity R₆ₘₐₓ and the individual minimum proximity R₆ₘᵢₙ of the sixth stage buffer (6) and allow the added FF/RAM (ADD.d) to belong to the inside of the proximity range of the new buffer (7E). A clock signal is distributed from the non-final stage buffer (6) to the added FF/RAM (ADD.d) through the new buffer (7E) of the seventh stage that is generated as above.

According to the process described above, there is no added FF/RAM to which the clock signal is distributed, and the clock distribution process for the added FF/RAM's ends.

### [4] Clock Signal Distribution Sequence According to Design Support Function Of This Embodiment

Next, the clock signal distribution sequence according to the design support function of this embodiment described above will be described in detail along a flowchart (Steps S201 to S206, S201a to S206a, and S23) illustrated in FIGS. 14 and 15.

When an FF or a RAM is added in accordance with the occurrence of a change in the logic or the like after the design of a design target circuit in advance, the following process is performed for a final stage buffer (first buffer) of a clock distribution circuit in existing physical design data as a processing target buffer (Step S201).

First, estimated maximum proximity and estimated minimum proximity used as maximum proximity and minimum proximity of an added buffer of a final stage that is newly generated or a final stage buffer to which two or more FF/RAM's or buffers are not connected on the lower stage side are calculated by the additional buffer proximity calculating unit 22b (Step S202). At this time, as described with reference to FIG. 3, a normalized distribution of the distance between each final stage buffer and a next stage (existing FF/RAM) of the final stage buffer is acquired. A distance corresponding to −30% from the center of this normalized distribution is acquired as the estimated minimum proximity, and a distance corresponding to +30% from the center is acquired as the estimated maximum proximity.

In addition, individual maximum proximity and individual minimum proximity of all the existing final stage buffers to which two or more FF/RAM's are connected are calculated by the final stage buffer proximity calculating unit 22a (Step S203). At this time, based on the existing physical design data, distances between the final stage buffer and a plurality of existing FF/RAM's connected to the lower stage side of the final stage buffer are calculated. Out of the calculated distances, a maximum value is used as the individual maximum proximity, and a minimum value is used as the individual minimum proximity.

In a case where two or more FF/RAM's are connected to the final stage buffer, the individual maximum proximity and the individual minimum proximity calculated in Step S203 are used as the maximum proximity and the minimum proximity (Step S204). However, in a case where two or more FF/RAM's are not connected to the final stage buffer, the estimated maximum proximity and the estimated minimum proximity calculated in Step S202 are used as the maximum proximity and the minimum proximity (Step S204).

After the maximum proximity and the minimum proximity are calculated, an added FF/RAM present between the maximum proximity and the minimum proximity (in the proximity range) of the final stage buffer is searched and determined by the search unit 23 (Step S205).

The added FF/RAM included in the proximity range of the final stage buffer is connected to the final stage buffer by the clock distribution unit 25, and a clock signal is distributed thereto (Step S206). At this time, in a case where the same added FF/RAM is included in the proximity ranges of a plurality of final stage buffers, a final stage buffer of an appropriate clock signal distribution source is selected in consideration of the fan-out number of the final stage buffer and a shortest wiring distance between the wiring possible area of the final stage buffer and the added FF/RAM (Step S206).

Thereafter, it is determined whether or not the clock signal has been distributed to all the added FF/RAM's (Step S23). In a case where the clock signal has been distributed to all the added FF/RAM's (Yes route of Step S23), the process of Steps S6 and S7 illustrated in FIG. 13 described above is performed.

On the other hand, in a case where there is an FF/RAM to which the clock signal has not been distributed, in other words, in a case where there is an added FF/RAM disposed outside the proximity range (No route of Step S23), the process proceeds to Step S201a. At this time, the following process is performed for a non-final stage buffer (second buffer) disposed on the upper stage side upper than the previous processing target buffer by one stage as the processing target buffer (Step S201a).

The estimated maximum proximity and the estimated minimum proximity used as the maximum proximity and the minimum proximity of the added buffer of the processing target stage that is newly generated or the processing target buffer to which two or more FF/RAM's or buffers are not connected on the lower stage side are calculated by the additional buffer proximity calculating unit 22b (Step S202a). At this time, as described above with reference to FIG. 3, a normalized distribution of the distance between each processing target buffer and the next stage (existing buffer) of the processing target buffer is acquired. A distance corresponding to −30% from the center of this normalized distribution is acquired as estimated minimum proximity, and a distance corresponding to +30% from the center is acquired as estimated maximum proximity.

In addition, individual maximum proximity and individual minimum proximity of all the exiting processing target buffers to which two or more FF/RAM's are connected are calculated by the final stage buffer proximity calculating unit 22a (Step S203a). At this time, based on the existing physical design data, distances between the processing target buffer and a plurality of existing buffers connected to the lower stage of the final stage buffer are calculated. Among the calculated distances, a maximum value is used as the individual maximum proximity, and a minimum value is used as the individual minimum proximity.

In a case where two or more FF/RAM's are connected to the processing target buffer, the maximum proximity and the minimum proximity of the non-final stage buffer are calculated by the non-final stage buffer proximity calculating unit 22c based on the individual maximum proximity and the individual minimum proximity calculated in Step S203a, the estimated maximum proximity and the estimated minimum proximity calculated in Step S202a, and Equations (1) and (2) described above (Step S204a).

After, the maximum proximity and the minimum proximity are calculated, an added FF/RAM present between the maximum proximity and the minimum proximity (proximity range) of the processing target buffer is searched and determined by the search unit 23 (Step S205a).

The added FF/RAM included in the proximity range of the processing target buffer is connected to the processing target buffer through a buffer of an appropriate stage number that is newly added and generated by the clock distribution unit 25, and a clock signal is distributed thereto (Step S206a). At this time, in a case where the same added FF/RAM is included in the proximity ranges of a plurality of processing target buffers, a processing target buffer of an appropriate clock signal distribution source is selected in consideration of the fan-out number of the processing target buffer and a shortest wiring distance between the wiring possible area of the processing target buffer and the added FF/RAM (Step S206a).

Thereafter, it is determined whether or not the clock signal has been distributed to all the added FF/RAM's (Step S23). In a case where the clock signal has been distributed to all the added FF/RAM's (Yes route of Step S23), the process of Steps S6 and S7, which are described above, illustrated in FIG. 13 is performed.

On the other hand, in a case where there is an added FF/RAM to which the clock signal has not been distributed, in other words, in a case where there is an added FF/RAM disposed outside the proximity range (No route of Step S23), the process proceeds to Step S201a. At that time, a non-final stage buffer (second buffer) disposed on the upper stage side upper than that of the previous processing target buffer by one stage is set as the processing target buffer. Then, the process of Steps S201a to S206a and S23 described above is repeatedly performed until the clock signal is distributed to all the added FF/RAM's (until Yes is determined in Step S23).

### [5] Advantage Of Design Support Device According To This Embodiment

According to the design support device 1 of this embodiment, based on the existing physical design data verified for the clock skew, the clock signal is distributed to the added FF/RAM such that the clock skew is within the maximum skew range (the limit range of the clock skew) of the existing circuit.

In addition, in a case where there are a plurality of buffers as distribution source candidates of the clock signal, an appropriate clock signal distribution source is selected in consideration of the fan-out number of each candidate buffer and a shortest wiring distance between the wiring possible area of the candidate buffer and the added FF/RAM.

Accordingly, without adjusting the timing of the existing circuit, in a case where an FF or a RAM is added in accordance with the occurrence of a change in the logic or the like after the design of the design target circuit in advance, the clock signal can be efficiently distributed in a short time. At this time, it is not necessary to perform the process of delay calculation and the like, and the clock signal can be distributed through a simple calculation process. Accordingly, in a case where there is a change in the clock tree after the completion of the physical design, the clock tree can be corrected using a simple technique.

### [6] Others

As above, while the preferred embodiments of the present invention have been described in detail, the present invention is not limited to a specific embodiment, but various modifications or changes may be made therein within the range not departing from the concept of the present invention.

In addition, in the specific examples of the above- described embodiments, while the case has been described in which the number of buffer stages of the clock distribution circuit is seven, the present invention is not limited thereto.

Furthermore, in the above-described embodiments, while the case has been described in which the distance from the processing target buffer to the FF/RAM or the next-stage buffer is a distance in a straight line from the processing target buffer to the FF/RAM or the next-stage buffer, the present invention is not limited thereto. Thus, for example, a wiring length such as a Manhattan length from the processing target buffer to the FF/RAM or the next-stage buffer may be used.

In addition, in the above-described embodiment, while the case has been described in which the sequential circuit is the FF or the RAM, the present invention is not limited thereto.

Furthermore, all or a part of various functions of the design support device 1 according to this embodiment including the data reading unit 21, the buffer proximity calculating unit 22, the search unit 23, the determination unit 24, the clock distribution unit 25, and the result storing unit 26 is realized by executing a predetermined application program (design support program) using a computer (including a CPU, an information processing apparatus, or various terminals).

The program, for example, is provided in a form being recorded in a computer-readable recording medium such as a flexible disk, a CD (a CD-ROM, a CD-R, a CD-RW, or the like), a DVD (a DVD-ROM, a DVD-RAM, a DVD-R, a DVD-RW, a DVD+R, a DVD+RW, or the like), or a Blu-ray disk. In such a case, the computer uses the program by reading the program from the recording medium and transmitting the program to an internal storage device or an external storage device so as to be stored therein.

Here, the computer has a concept including hardware and an OS (operating system) and represents the hardware operating under the control of the OS. In addition, in a case where the OS is not necessary, and the hardware is operated by an independent application program, the hardware corresponds to the computer. The hardware includes at least a microprocessor such as a CPU and a means for reading the computer program recorded on a recording medium. The design support program includes a program code for realizing various functions of the design support device 1 according to this embodiment including the data reading unit 21, the buffer proximity calculating unit 22, the search unit 23, the determination unit 24, the clock distribution unit 25, and the result storing unit 26 in the computer. Some of the functions may be realized not by the application program but by the OS.

According to an embodiment, in a case where there is a change in the clock tree after the completion of the physical design, the clock tree can be corrected using a simple technique.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A design support device comprising:
a memory configured to store physical design data of a circuit that includes a clock distribution circuit having a buffer; and
a processor,
wherein the processor, when a sequential circuit to which a clock signal distributed by a first buffer included in the clock distribution circuit is input is added, in a case where a plurality of other sequential circuits are connected to the first buffer, determines whether or not a distance between the sequential circuit to be added and the first buffer is between a maximum value and a minimum value of distances between the first buffer and the plurality of other sequential circuits based on the physical design data stored in the memory, and
wherein, as a result of the determination, in a case where the distance between the sequential circuit to be added and the first buffer is between the maximum value and the minimum value, the processor performs wiring processing of the clock signal supplied from the first buffer for the sequential circuit to be added.

2. The design support device according to claim 1, wherein, in a case where the plurality of other sequential circuits are not connected to the first buffer, the processor calculates a normalized distribution having a mean and a variance of distances between the buffer to which the plurality of other sequential circuits are connected and the plurality of connected other sequential circuit based on the physical design data stored in the memory, sets a distance corresponding to an upper limit of a predetermined range of the normalized distribution as the maximum value, and sets a distance corresponding to a lower limit of the predetermined range of the normalized distribution as the minimum value.

3. The design support device according to claim 1,
wherein, as a result of the determination, in a case where the distance between the sequential circuit to be added and the first buffer is not between the maximum value and the minimum value, the processor calculates a maximum value of a distance at which the clock signal can be distributed from a second buffer provided on an upper side of the first buffer to the sequential circuit to be added and a minimum value of the distance at which the clock signal can be distributed from the second buffer to the sequential circuit to be added based on the physical design data stored in the memory, and determines whether or not the distance between the sequential circuit to be added and the second buffer is between the maximum value and the minimum value of the distance at which the clock signal can be distributed, and
wherein, as a result of the determination, in a case where the distance between the sequential circuit to be added and the second buffer is between the maximum value and the minimum value of the distance at which the clock signal can be distributed, the processor performs wiring processing of the clock signal supplied from the second buffer for the sequential circuit to be added.

4. The design support device according to claim 3,
wherein the maximum value of the distance at which the clock signal can be distributed is a value acquired by adding a first maximum value of distances from the second buffer to a plurality of next-stage buffers connected a lower side of the second buffer and a sum of second maximum values, each of the second maximum values being the first maximum value acquired for each of buffers from the next-stage buffers to the first buffer, and
wherein the minimum value of the distance at which the clock signal can be distributed is a larger value of a value, which is acquired by subtracting the sum of the second maximum values from a first minimum value of the distances from the second buffer to the plurality of next-stage buffers connected to the lower side of the second buffer, and zero.

5. The design support device according to claim 1, wherein, in a case where the distances between the sequential circuit to be added and a plurality of the first buffers are between the maximum value and the minimum value, the processor selects one of the plurality of the first buffers having a least fan-out number, and performs wiring processing of the clock signal supplied from the selected first buffer for the sequential circuit to be added.

6. The design support device according to claim 1, wherein, in a case where the distances between the sequential circuit to be added and a plurality of the first buffers are between the maximum value and the minimum value, the processor selects one of the plurality of the first buffers for which a wiring distance up to the sequential circuit to be added is minimal and performs wiring processing of the clock signal supplied from the selected first buffer for the sequential circuit to be added.

7. The design support device according to claim 6, wherein the processor, for each of the plurality of the first buffers, acquires an area in which there is a possibility of wiring of the clock signal from the each of the plurality of the first buffers to an existing sequential circuit based on the physical design data stored in the memory, and selects one of the plurality of the first buffers for which a distance from the sequential circuit to be added to the area is minimal as the first buffer for which the wiring distance is minimal.

8. The design support device according to claim 3, wherein the distance is a distance in a straight line from the first buffer to the plurality of other sequential circuits or a distance in a straight line from the second buffer to the next-stage buffer.

9. The design support device according to claim 3, wherein the distance is a wiring length from the first buffer to the plurality of other sequential circuits or a wiring length from the second buffer to the next-stage buffer.

10. A method of performing design support using a processor based on physical design data of a circuit that includes a clock distribution circuit having a buffer, physical design data being stored in a memory, the method comprising:
determining whether or not a distance between a sequential circuit to be added and a first buffer is between a maximum value and a minimum value of distances between the first buffer and the plurality of other sequential circuits based on the physical design data in a case where a plurality of other sequential circuits are connected to the first buffer when the sequential circuit to which a clock signal distributed by the first buffer included in the clock distribution circuit is input is added; and
performing wiring processing of the clock signal supplied from the first buffer for the sequential circuit to be added in a case where the distance between the sequential circuit to be added and the first buffer is between the maximum value and the minimum value as a result of the determining.

11. The method according to claim 10, wherein, in a case where the plurality of other sequential circuits are not connected to the first buffer, a normalized distribution having a mean and a variance of distances between the buffer to which the plurality of other sequential circuits are connected and the plurality of connected other sequential circuit is calculated based on the physical design data, a distance corresponding to an upper limit of a predetermined range of the normalized distribution is set as the maximum value, and a distance corresponding to a lower limit of the predetermined range of the normalized distribution is set as the minimum value.

12. The method according to claim 10,
wherein, as a result of the determining, in a case where the distance between the sequential circuit to be added and the first buffer is not between the maximum value and the minimum value, a maximum value of a distance at which the clock signal can be distributed from a second buffer provided on an upper side of the first buffer to the sequential circuit to be added and a minimum value of the distance at which the clock signal can be distributed from the second buffer to the sequential circuit to be added is calculated based on the physical design data, and whether or not the distance between the sequential circuit to be added and the second buffer is between the maximum value and the minimum value of the distance at which the clock signal can be distributed is determined, and
wherein, as a result of the determining, in a case where the distance between the sequential circuit to be added and the second buffer is between the maximum value and the minimum value of the distance at which the clock signal can be distributed, wiring processing of the clock signal supplied from the second buffer is performed for the sequential circuit to be added.

13. A computer-readable recoding medium having stored therein a design support program for causing a computer to execute a process for performing design support based on physical design data of a circuit including a clock distribution circuit having a buffer, physical design data being stored in a memory, the process comprising:
determining whether or not a distance between a sequential circuit to be added and a first buffer is between a maximum value and a minimum value of distances between the first buffer and the plurality of other sequential circuits based on the physical design data in a case where a plurality of other sequential circuits are connected to the first buffer when the sequential circuit to which a clock signal distributed by the first buffer included in the clock distribution circuit is input is added; and
performing wiring processing of the clock signal supplied from the first buffer for the sequential circuit to be added in a case where the distance between the sequential circuit to be added and the first buffer is between the maximum value and the minimum value as a result of the determining.

14. The computer-readable recoding medium according to claim 13, wherein, in a case where the plurality of other sequential circuits are not connected to the first buffer, a normalized distribution having a mean and a variance of distances between the buffer to which the plurality of other sequential circuits are connected and the plurality of connected other sequential circuit is calculated based on the physical design data, a distance corresponding to an upper limit of a predetermined range of the normalized distribution is set as the maximum value, and a distance corresponding to a lower limit of the predetermined range of the normalized distribution is set as the minimum value.

15. The computer-readable recoding medium according to claim 13,
wherein, as a result of the determining, in a case where the distance between the sequential circuit to be added and the first buffer is not between the maximum value and the minimum value, the process further comprising:
calculating a maximum value of a distance at which the clock signal can be distributed from a second buffer provided on an upper side of the first buffer to the sequential circuit to be added and a minimum value of the distance at which the clock signal can be distributed from the second buffer to the sequential circuit to be added based on the physical design data; and
determining whether or not the distance between the sequential circuit to be added and the second buffer is between the maximum value and the minimum value of the distance at which the clock signal can be distributed, and
wherein, as a result of the determining, in a case where the distance between the sequential circuit to be added and the second buffer is between the maximum value and the minimum value of the distance at which the clock signal can be distributed, the process further comprises performing wiring processing of the clock signal supplied from the second buffer for the sequential circuit to be added.
